(19) United States
(12) Patent Application Publication
(10) Pub. No.: US 2010/0049961 A1
(43) Pub. Date: Feb. 25, 2010

(54) UPDATE METHOD FOR BASIC INPUT/OUTPUT SYSTEM AND UPDATE SYSTEM THEREOF

(75) Inventor: Ke-Chih Liao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/534,847

(22) Filed: Aug. 3, 2009

(30) Foreign Application Priority Data
Aug. 22, 2008 (TW) 97132242

(51) Int. Cl. G06F 9/00; G06F 11/07

(52) U.S. Cl. 713/2; 714/2

(57) ABSTRACT

An update method for a basic input/output system (BIOS) and an update system thereof are provided. Firstly, a program code of a boot block included in a main BIOS block is executed to detect whether the main BIOS block is crashed. A program code of the BIOS is stored in the main BIOS block. A BIOS image file is searched from a storage device when the main BIOS block is crashed, which includes a program code of a graphical user interface (GUI) and a plurality of update files. The program code of the GUI is executed to display graphic updating information of the BIOS. One of the update files is selected by a control command to update the main BIOS block. Therefore, the needed update file can be selected to update the BIOS by graphically display the updating information of the bios, thereby improving the update efficiency and usage convenience.

### CROSS-REFERENCE TO RELATED APPLICATION

This application claims the priority benefit of Taiwan application serial no. 97132242, filed on Aug. 22, 2008. The entirety of the above-mentioned patent application is hereby incorporated by reference herein and made a part of specification.

### BACKGROUND OF THE INVENTION

1. Field of the Invention

The present invention generally relates to an update method for a basic input/output system (BIOS) and an update system thereof, in particular, to a method for displaying updating information of a basic input/output system (BIOS) via a graphical user interface (GUI) and a system thereof.

2. Description of Related Art

A basic input/output system (BIOS) is the most fundamental software program code in a computer system, which mainly functions to perform a power on self test (POST) when the computer system is booted, so as to detect whether the hardware devices configured in the computer system is in a normal status or not. The program code of the BIOS is generally stored in a nonvolatile memory such as a flash memory, and a memory block that stores the program code of the BIOS is generally referred to as a main BIOS block, which includes a boot block and a main program block.

When the computer system is booted, a program code of the boot block is executed first, so as to verify whether the other portions of the BIOS are normal or not via a checksum before running the BIOS. After the boot block successfully passes through the verification, a program code in the main program block is executed to perform a POST, initialize hardware devices, and record default values of the system. If an error of the program code of the BIOS is detected, the BIOS must be updated, in order to complete the booting procedure.

Generally, if the BIOS fail to be booted, a floppy disk storing the BIOS files must be loaded into the disk driver of the computer system, such that the computer system automatically searches whether there are complete BIOS files or not when executing the program code of the boot block. However, the conventional update methods for the BIOS can only inform a user whether BIOS files are found or not via a text interface and then update the BIOS, but the user cannot select a needed file for update.

### SUMMARY OF THE INVENTION

Accordingly, the present invention is directed to an update method for a basic input/output system (BIOS) and an update system thereof, which can displaying updating information and selecting a needed update file via a graphical user interface (GUI) when executing the BIOS updating.

As embodied and broadly described herein, the present invention provides an update method for a basic input/output system (BIOS). A program code of the BIOS is stored in a main BIOS block, and the main BIOS block includes a boot block. Firstly, a program code of the boot block is executed to detect whether the main BIOS block is crashed or not. Then, when the main BIOS block is crashed, a BIOS image file is searched from a storage device. The BIOS image file includes a program code of a graphical user interface (GUI) and a plurality of update files. The program code of the GUI is executed to graphically display information of the BIOS. One of the update files is selected by a control command, so as to update the main BIOS block.

The present invention further provides an update system for a basic input/output system (BIOS), which includes a main BIOS block, a storage device, and a memory module. The main BIOS block stores a program code of the BIOS. The storage device stores a BIOS image file. The BIOS image file includes a program code of a graphical user interface (GUI) and a plurality of update files. When the update system detects that the main BIOS block is crashed, the update system loads the program code of the GUI from the storage device into the memory module and executes the program code of the GUI, so as to graphically display updating information of the BIOS. The update system selects one of the update files by a control command, so as to update the main BIOS block.

In the present invention, the updating information of the bios is displayed graphically to enable a user to select the needed update file via the GUI, so as to update the BIOS. As compared with conventional methods that the user is informed about the existence of the update files via a text interface and then the entire main BIOS block is updated, the present invention not only enhances the BIOS update efficiency, but also improves the usage convenience of the BIOS.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an update system for a basic input/output system according to an embodiment of the present invention.

FIG. 2 is a flow chart of an update method for a basic input/output system according to an embodiment of the present invention.

FIG. 3 is a schematic view of a GUI according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

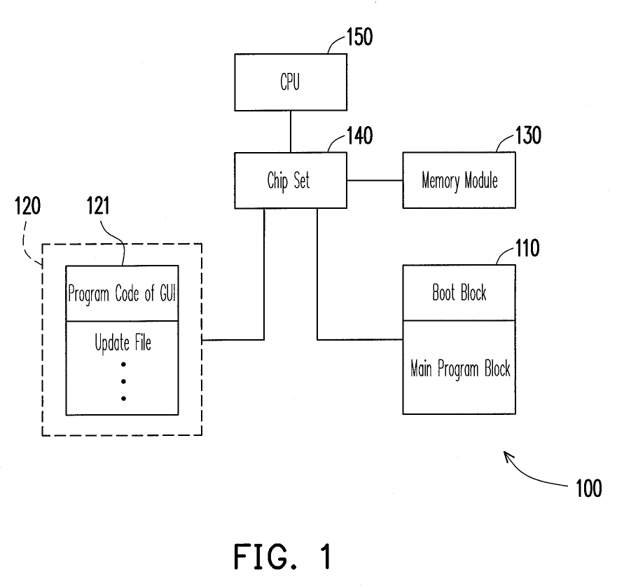

FIG. 1 is a block diagram of an update system for a basic input/output system according to an embodiment of the present invention. Referring to FIG. 1, an update system of this embodiment constitutes a part of a computer system 100, and includes a main BIOS block 110, a memory module 130, and a storage device 120. The main BIOS block 110 is generally a nonvolatile memory (for example, a flash memory) for storing a program code of the BIOS, and includes a boot block and a main program block. The memory module 130 is a main memory in the computer system 100, which exchanges data with a central processing unit (CPU) 150 via a chip set 140, so as to register program instructions and store operation results and data to be output. The storage device 120 is, for example, an optical disk, a floppy disk, a hard disk, or a universal serial bus (USB) device for storing a BIOS image file 121. The BIOS image file 121 includes a program code of a graphical user interface (GUI) and a plurality of update files.

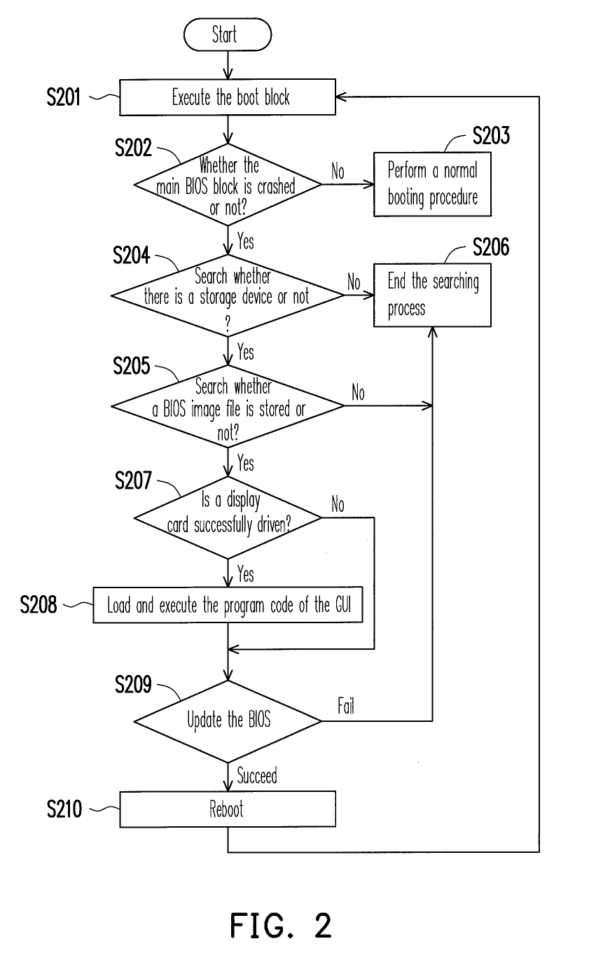

FIG. 2 is a flow chart of an update method for a basic input/output system according to an embodiment of the present invention. Referring to FIGS. 1 and 2, when the computer system 100 is booted, a program code of the boot block is executed first (Step S201), so as to verify whether the main BIOS block 110 is crashed or not via a checksum (Step S202), for example, whether there is an error in the program code of the BIOS or the computer system 100 is required to support a new hardware. If the main BIOS block 110 is verified to be in a normal status, a program code of the main program block is executed to perform a power on self test (POST), initialize hardware devices, and record default values of the system, and subsequently, a normal booting procedure is performed (Step S203). When the main BIOS block 110 is crashed, the update system searches whether there is an additional storage device 120 in the computer system 100 or not (Step S204). If yes, the update system further searches whether the storage device 120 stores a BIOS image file 121 for update (Step S205). If no additional storage device 120 is searched or the storage device 120 does not store any BIOS image file 121, the searching process is ended (Step S206) and the BIOS will not be updated.

In this embodiment, if the storage device 120 stores a BIOS image file 121 for update, the update system detects whether there is a compatible graphic card such as a video graphics array (VGA) graphic card in the computer system 100 or not, and if yes, it drives the graphic card (Step S207), so as to display a GUI. After the graphic card is successfully driven, the update system loads a program code of the GUI into the memory module 130 (Step S208) and executes the program code of the GUI, so as to display graphic updating information of the BIOS such as file names or storage paths of the update files. The update system can interact with a user via the GUI to select a needed update file by a control command (for example, a command input through a mouse or a keyboard) to update the main BIOS block 110 (Step S209).

In addition, as shown in Step S207, if no compatible graphic card is detected or the graphic card fails to be driven, the update system automatically retrieves the update files in the BIOS image file 121 to update the entire main BIOS block 110 (Step S209). After the main BIOS block is updated, the update system reboots the computer system (Step S210).

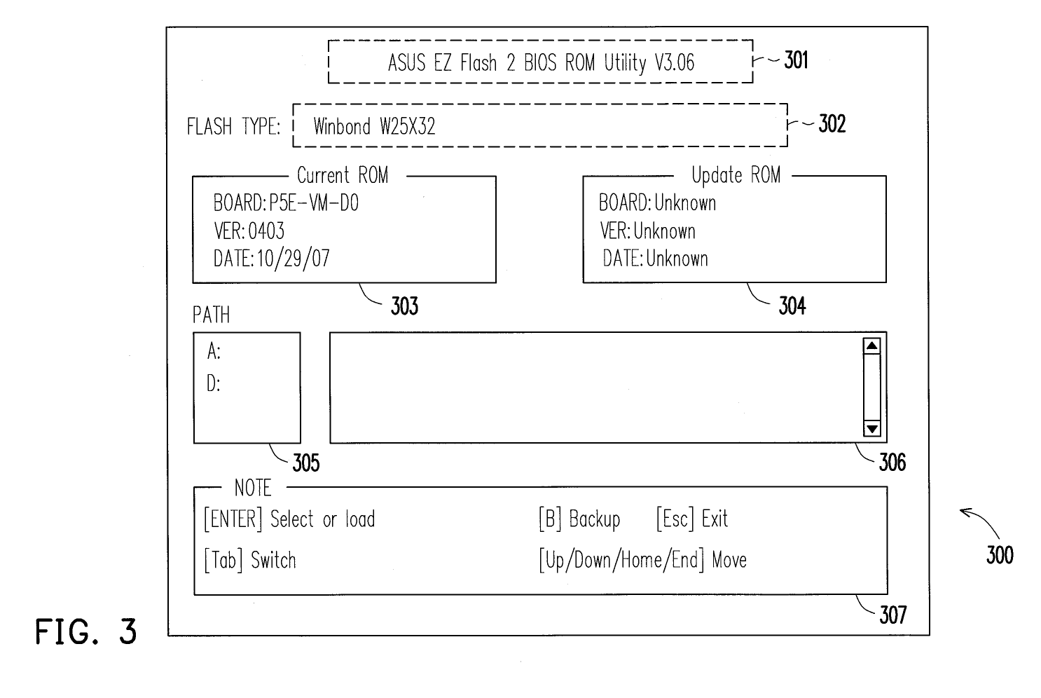

FIG. 3 is a schematic view of a GUI according to an embodiment of the present invention. Referring to FIG. 3, in a GUI 300, Block 301 shows version information of a utility provided in this embodiment, Block 302 shows a model of a flash memory for storing the program code of the BIOS, and Block 303 shows a model of a motherboard suitable for the current firmware, a version of the firmware, and an update date of the firmware. A user operates a keyboard according to instructions in Block 307 (i.e., generating a control command) to select a storage device from storage devices shown in Block 305, for example, a floppy disk A or a hard disk D, and thus, update files stored in the storage device are shown in Block 306. Moreover, the user can also select a needed update file from the update files shown in Block 306 in the above manner. In this case, Block 304 shows a motherboard suitable for the selected update file, as well as its version and update date. The user may determine whether the current firmware is the latest version or not by comparing information shown in Block 303 with that shown in Block 304, or may perform a further update.

It should be noted that, conventionally, the main program block in the main BIOS block 110 stores a program code of a GUI set by the BIOS, so that the user is enabled to set the working frequency and system time of the computer system 100 via the GUI set by the BIOS. However, if the main BIOS block is crashed, the program code of the GUI set by the BIOS cannot be executed. Different from the conventional GUI set by the BIOS, the GUI of this embodiment shows update files included in the graphically displayed BIOS image file 121, so that the user can select a needed update file therefrom to update the main BIOS block.

To sum up, the above embodiments detect whether the main BIOS block is crashed or not by executing the program code of the boot block. When the main BIOS block is crashed, for example, an error occurs to the program code of the BIOS, a backup BIOS image file is loaded from the storage device. Particularly, such a BIOS image file includes a program code of a GUI and update files. Furthermore, information of the update files can be graphically displayed on the GUI by executing the program code of the GUI. Hence, a needed update file can be selected on the GUI by a control command to update the BIOS. Therefore, not only the usage convenience is improved, but the update efficiency is also enhanced, since a portion of the BIOS that needs to be repaired is particularly updated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An update method for a basic input/output system (BIOS), comprising:
executing a program code of a boot block to detect whether a main BIOS block is crashed or not, wherein the main BIOS block comprises the boot block and stores a program code of the BIOS;
searching a BIOS image file from a storage device when the main BIOS block is crashed, wherein the BIOS image file comprises a program code of a graphical user interface (GUI) and a plurality of update files;
executing the program code of the GUI to graphically display updating information of the BIOS; and
selecting one of the update files by a control command, so as to update the main BIOS block.

2. The update method according to claim 1, further comprising:
detecting whether a compatible graphic card exists or not; and
driving the graphic card to display the GUI, when the graphic card exists.

3. The update method according to claim 1, further comprising:
rebooting the computer system, after the main BIOS block is updated.

4. The update method according to claim 1, wherein the information of the update files comprises file names or storage paths of the update files.

5. The update method according to claim 1, wherein the storage device is any one selected from a group consisting of an optical disk, a floppy disk, a hard disk, and a universal serial bus (USB) device, or any combination thereof.

6. An update system for a basic input/output system (BIOS), comprising:
a main BIOS block, for storing a program code of the BIOS;
a storage device, for storing a BIOS image file, wherein the BIOS image file comprises a program code of a graphical user interface (GUI) and a plurality of update files; and
a memory module, wherein when the main BIOS block is crashed, the update system loads the program code of the GUI into the memory module and executes the program code of the GUI to graphically display updating information of the BIOS, and selects one of the update files by a control command, so as to update the main BIOS block.

7. The update system according to claim 6, wherein the main BIOS block comprises a boot block and the update system executes a program code of the boot block to detect whether the main BIOS block is crashed or not.

8. The update system according to claim 6, wherein the information of the update files comprises file names or storage paths of the update files.

9. The update system according to claim 6, wherein the storage device is any one selected from a group consisting of an optical disk, a floppy disk, a hard disk, and a universal serial bus (USB) device, or any combination thereof.
